(19) United States
(12) Patent Application Publication
(10) Pub. No.: US 2025/0363688 A1
(43) Pub. Date: Nov. 27, 2025

(54) DOCUMENT AGNOSTIC PERFORMANCE ENHANCEMENT THROUGH MULTI-STAGE MIXED LEVEL OF DETAIL RENDERING

(71) Applicant: Adobe Inc., San Jose, CA (US)

(72) Inventors: Deepak Kumar Sharma, Chhoti Sadri (IN); Ankur Krishna Gautam, Noida (IN); Angad Kumar Gupta, Noida (IN)

(21) Appl. No.: 18/673,861

(22) Filed: May 24, 2024

(51) Int. Cl. G06T 11/60; G06T 5/50

(52) U.S. Cl. CPC G06T 11/60; G06T 5/50; G06T 2207/20221

(57) ABSTRACT

The present disclosure relates to systems, non-transitory computer-readable media, and methods for providing a mixed level-of-detail rendering of a vector graphics document for display and modification via a client device while downloading and rendering the full vector graphics document. In particular, the disclosed systems download, in response to a request to load a vector graphics document at a client device, a raster image of the vector graphics document. Moreover, the disclosed systems select and download a vector graphic subunit of the vector graphics document, for example, by selecting a priority graphic design layout boundary. Furthermore, the disclosed systems provide, for display via the client device, a mixed level-of-detail rendering comprising the raster image of the vector graphics document and the vector graphic subunit as an overlay of the raster image such that the client device can modify the vector graphic subunit while downloading an additional vector graphic subunit.

### BACKGROUND

Recent years have seen significant improvements in technology and software for creating and using intricate vector graphics in many different digital graphics environments. Specifically, vector-based graphics provide lossless scaling of images for achieving resolution independence, which is particularly useful in converting digital images to print or for use across many different types of media. Creating and manipulating vector graphics, however, can result in large files to store large amounts of digital data associated with vector-based image formats. To illustrate, a single vector graphics document often has many different layers including many different anchor points, paths, and complex constructs such as repeats, gradient fills, clipping paths, compound paths, blending modes, etc., spanning across numerous artboards (or frames). Accordingly, managing such large vector graphics documents is an important, but often unwieldy, task given various constraints on computing and communication resources. Additionally, although conventional systems are capable of creating and manipulating large vector graphics documents, they have a number of technical deficiencies with regard to efficiently handling files with such complexity.

### SUMMARY

Embodiments of the present disclosure provide benefits and/or solve one or more of the foregoing or other problems in the art with systems, non-transitory computer-readable media, and methods for providing a mixed level-of-detail rendering of a vector graphics document for display and modification while downloading and rendering the full vector graphics document. In particular, the disclosed systems download and render a raster image of the vector graphics document in response to a request to load the vector graphics document. Further, in some embodiments, the disclosed systems select a graphic design layout boundary representing a portion of the vector graphics document and mask the correlating portion of the raster image. Moreover, in these or other embodiments, the disclosed systems select a vector graphic subunit of the vector graphics document associated with the graphic design layout boundary to download and render within the masked area of the raster image. Furthermore, the disclosed systems render the vector graphic subunit with the raster image such that a client device can modify the vector graphic subunit while the disclosed systems continue downloading additional vector graphic subunits. Additionally, in some implementations, the disclosed systems repeat the foregoing process by continuing to identify and render additional vector graphic subunits for display with the raster image until the vector graphics document is fully downloaded and rendered, replacing the raster image.

Additional features and advantages of one or more embodiments of the present disclosure are outlined in the description which follows, and in part can be determined from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which a mixed detail rendering system operates in accordance with one or more embodiments.

FIG. 2 illustrates a process flow of generating a mixed level-of-detail rendering from a raster image and a vector graphic subunit.

FIG. 3 illustrates a process flow of generating a mixed level-of-detail rendering utilizing a raster image in accordance with one or more embodiments.

FIG. 4 illustrates a process flow of identifying and providing a vector graphic subunit for display in accordance with one or more embodiments.

FIG. 5 illustrates a process flow of generating and providing for display a mixed level-of-detail rendering in accordance with one or more embodiments.

FIG. 6 illustrates a process flow of repeatedly selecting and downloading vector graphic subunits for display as part of the mixed level-of-detail rendering in accordance with one or more embodiments.

FIG. 7 illustrates vector graphic rendering times achieved by the mixed detail rendering system compared with example prior art vector graphic rendering times in accordance with one or more embodiments.

FIG. 8 illustrates an example schematic diagram of the mixed detail rendering system in accordance with one or more embodiments.

FIG. 9 illustrates an example series of acts for providing a mixed level-of-detail rendering of a vector graphics document for display via a client device in accordance with one or more embodiments.

FIG. 10 illustrates an example series of acts for providing a mixed level-of-detail rendering of a vector graphics document for display via a client device in accordance with one or more embodiments.

FIG. 11 illustrates an example series of acts for providing a mixed level-of-detail rendering of a vector graphics document for display via a client device in accordance with one or more embodiments.

FIG. 12 illustrates a block diagram of an example computing device for implementing one or more embodiments of the present disclosure.

### DETAILED DESCRIPTION

This disclosure describes one or more embodiments of a mixed detail rendering system that provides a mixed level-of-detail rendering of a vector graphics document for display and modification while downloading and rendering the full vector graphics document. In particular, the mixed detail rendering system downloads and renders a raster image of the vector graphics document in response to a request to load the vector graphics document. Further, in one or more embodiments, the mixed detail rendering system selects a graphic design layout boundary representing a portion of the vector graphics document and masks the correlating portion of the raster image. Moreover, in these or other embodiments, the mixed detail rendering system selects a vector graphic subunit of the vector graphics document associated with the graphic design layout boundary to download and render within the masked area of the raster image. Furthermore, the mixed detail rendering system renders the vector graphic subunit with the raster image such that a client device can modify the vector graphic subunit while the mixed detail rendering system continues downloading additional vector graphic subunits. Additionally, in one or more implementations, the mixed detail rendering system repeats the foregoing process by continuing to identify and render additional vector graphic subunits for display with the raster image, thereby fully downloading and rendering the vector graphics document and replacing the raster image.

As mentioned above, in some embodiments, the mixed detail rendering system renders a raster image of the vector graphics document in response to a request to load the vector graphics document. Further, in some implementations, the mixed detail rendering system selects a graphic design layout boundary representing a physical portion of the vector graphics document and masks the correlating portion of the raster image. Specifically, the mixed detail rendering system identifies a plurality of graphic design layout boundaries (e.g., artboards or other graphic areas) within the vector graphics document and selects a priority graphic design layout boundary. The mixed detail rendering system determines the priority graphic design layout boundary from the plurality of graphic design layout boundaries, for example, by determining historical user interactions with the vector content within the vector graphics document. Moreover, in one or more embodiments, the mixed detail rendering system utilizes the selected graphic design layout boundary to identify and mask a portion of the raster image correlating to the graphic design layout boundary.

As noted above, in one or more implementations, the mixed detail rendering system selects a vector graphic subunit of the vector graphics document associated with the graphic design layout boundary to download and render within the masked area of the raster image. In particular, the mixed detail rendering system determines graphic layers of the vector graphics document within the selected graphic design layout boundary using a layer list. Indeed, in some embodiments, the mixed detail rendering system generates a layer list for the graphic design layout boundary that identifies the graphic layers and the vector graphics of the graphic layers that are within the graphic design layout boundary. Furthermore, in some implementations, the mixed detail rendering system downloads the vector graphic subunit comprising the graphic layers and vector graphics within the graphic design layout boundary for rendering with the raster image.

As mentioned previously, in one or more embodiments, the mixed detail rendering system renders the vector graphic subunit with the raster image such that a client device can modify the vector graphic subunit while the mixed detail rendering system continues downloading additional vector graphic subunits. Specifically, the mixed detail rendering system generates a clipped vector graphic subunit by clipping the vector graphics of the vector graphic subunit to the graphic design layout boundary. Additionally, in one or more implementations, the mixed detail rendering system provides the clipped vector graphic subunit with the clipped raster image. In particular, the mixed detail rendering system provides the clipped vector graphic subunit as an overlay of the clipped raster image. Accordingly, the mixed detail rendering system generates a mixed level-of-detail rendering of the vector graphics document with the clipped vector graphic subunit rendered within the masked area of the raster image corresponding to the graphic design layout boundary.

As noted previously, in some embodiments, the mixed detail rendering system repeats the foregoing process by continuing to identify and render additional vector graphic subunits for display with the raster image to fully download and render the vector graphics document, thereby replacing the raster image. In particular, the mixed detail rendering system continues to identify priority graphic design layout boundaries from the plurality of graphic design layout boundaries of the vector graphics document. In these or other embodiments, the mixed detail rendering system masks an additional area of the raster image corresponding to the next priority graphic design layout boundary, identifies and downloads an additional vector graphic subunit corresponding to the next priority graphic design layout boundary, clips the additional vector graphic subunit to the graphic design layout boundary, and generates the mixed level-of-detail rendering with each of the downloaded and clipped vector graphic subunits as overlays of the raster image in the appropriate graphic design layout boundary.

Although some conventional systems create and manipulate vector graphics, such systems have a number of problems in relation to accuracy and efficiency, and flexibility of operation. For instance, conventional systems inefficiently access large and complex vector graphics documents. More specifically, conventional systems generally download all components of vector graphics documents prior to rendering any portion of the vector graphics documents. The inability to render the components individually before downloading all the components of the vector graphics document results in inefficiencies of conventional systems, particularly as file size and complexity of vector graphics documents grow. Indeed, the time required to download the file is typically directly proportional to the size of the file. Thus, conventional systems use computing resources for longer than necessary, particularly in use cases involving mobile devices and/or devices with slow download speeds by not making any portion of downloaded files available more rapidly.

In addition to their inefficiencies, conventional systems inaccurately render objects belonging to different layers in some cases. Specifically, certain conventional systems download and render large vector graphics documents by incrementally downloading large files component by component. This component-wise approach to downloading large vector graphics documents, however, fails to maintain fidelity in complex design scenarios. Indeed, downloading portions of vector content leads to incomplete and jarring content displays and does not permit client devices to perform meaningful operations. Moreover, conventional systems often exacerbate jarring displays because these systems cannot meaningfully determine the order in which the objects should be rendered.

Furthermore, conventional systems demonstrate operational inflexibility by lacking the ability to render large vector graphics documents according to differing pathways. For instance, some conventional systems do not include a mechanism for adjusting between pathways for incremental downloading and rendering of vector graphics documents. For example, even conventional systems that incrementally download large files component by component lack any mechanism for varying the order in which components are downloaded and rendered while maintaining accuracy.

As suggested by the foregoing, the mixed detail rendering system provides a variety of technical advantages relative to conventional systems. For example, in one or more implementations, by prioritizing vector graphic subunits for download and providing the priority vector graphic subunits as part of a mixed level-of-detail rendering for display in parallel with downloading additional vector graphic subunits, the mixed detail rendering system improves efficiency relative to conventional systems. Specifically, the mixed detail rendering system can free up computing resources by making downloaded data available for rendering much more quickly. For example, in one or more implementations, the mixed detail rendering system determines graphic design layout boundaries and leverages layer lists including vector graphic subunits of a vector graphics document for rapid mixed level-of-detail rendering of the vector graphics document. Further, the mixed detail rendering system can render the downloaded data while continuing to download additional graphic design layout boundaries and corresponding vector graphic subunits according to determined download priorities of the vector graphic subunits. Thus, in one or more implementations, the mixed detail rendering system renders the highest priority data in a shorter time, thereby freeing up valuable computing resources for users to view and interact with a vector graphics document more quickly.

Furthermore, in one or more implementations, by prioritizing and downloading vector graphics documents incrementally in meaningful pieces (e.g., graphic design layout boundary by graphic design layout boundary), the mixed detail rendering system improves accuracy relative to conventional systems. Specifically, in one or more embodiments, the mixed detail rendering system clips vector graphic subunits to corresponding graphic design layout boundaries to prevent vector graphics of the vector graphic subunit from being rendered incorrectly (e.g., being rendered on adjacent raster image portions of a mixed level-of-detail rendering). Additionally, in some implementations the mixed detail rendering system leverages layer lists to download and render a vector graphics document beginning with specific graphic design layout boundaries and corresponding vector graphic subunits. By downloading and rendering graphic design layout boundaries with corresponding vector graphic subunits according to graphic design layout boundary-specific layer lists, the mixed detail rendering system can improve accuracy of the rendered data. Indeed, in one or more implementations, the mixed detail rendering system renders the vector graphics accurately regardless of the order in which they are downloaded because the prioritized download system downloads and renders the vector graphics document graphic design layout boundary by graphic design layout boundary.

Moreover, in one or more implementations, by selecting graphic design layout boundaries based on priority information to incrementally download and render portions of vector graphics documents, the mixed detail rendering system improves flexibility relative to conventional systems. Specifically, by determining a priority graphic design layout boundary and leveraging corresponding layer lists, the mixed detail rendering system can determine varying pathways for incrementally downloading and rendering graphic design layout boundaries and their corresponding vector graphic subunits. For example, in one or more implementations, the mixed detail rendering system determines a priority graphic design layout boundary based on a variety of factors including, by way of example and not limitation, historical interactions and/or a measure of relevance. Thus, by considering a variety of factors, the mixed detail rendering system can determine a variety of download priorities with which to proceed in determining graphic design layout boundaries and corresponding vector graphic subunits for prioritized incremental download.

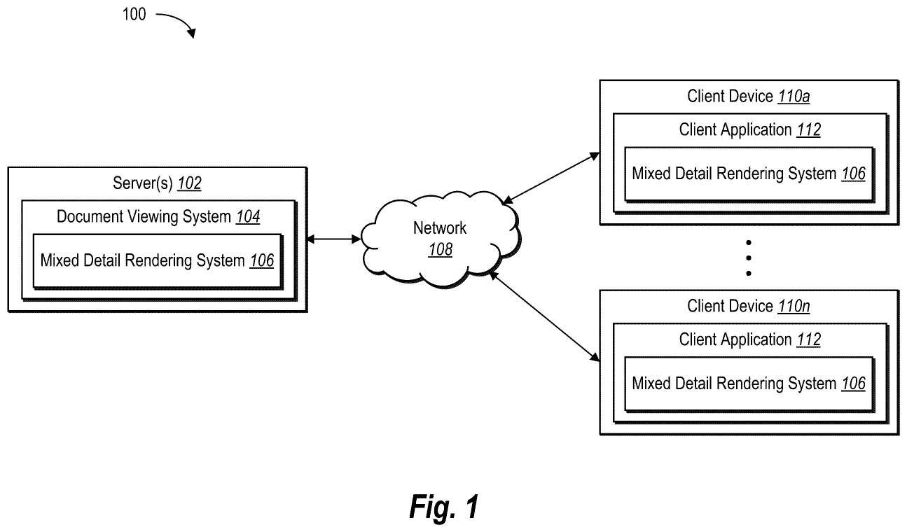

Additional detail regarding the mixed detail rendering system will now be provided with reference to the figures. For example, FIG. 1 illustrates a schematic diagram of a system environment 100 in which a mixed detail rendering system 106 operates. As illustrated in FIG. 1, the system environment 100 includes server(s) 102, a network 108, and client devices 110a-110n.

Although the system environment 100 of FIG. 1 is depicted as having a particular number of components, the system environment 100 is capable of having any number of additional or alternative components (e.g., any number of servers, client devices, or other components in communication with the mixed detail rendering system 106 via the network 108). Similarly, although FIG. 1 illustrates a particular arrangement of the server(s) 102, the network 108, and the client devices 110a-110n, various additional arrangements are possible.

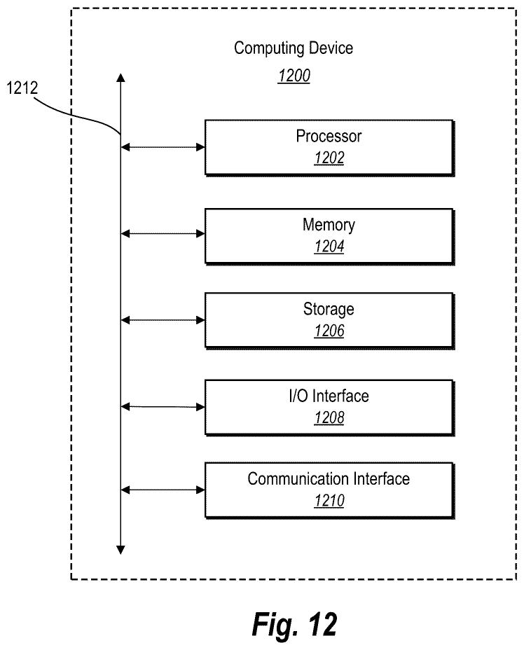

The server(s) 102, the network 108, and the client devices 110a-110n are communicatively coupled with each other either directly or indirectly (e.g., through the network 108 discussed in greater detail below in relation to FIG. 12). Moreover, the server(s) 102 and the client devices 110a-110n include one or more of a variety of computing devices (including one or more computing devices as discussed in greater detail with relation to FIG. 12).

As mentioned above, the system environment 100 includes the server(s) 102. In one or more embodiments, the server(s) 102 generates, stores, receives, and/or transmits data, including vector graphics documents and layer lists associated therewith. In one or more embodiments, the server(s) 102 comprises a data server. In some implementations, the server(s) 102 comprises a communication server or a web-hosting server.

In one or more embodiments, the document viewing system 104 provides functionality by which a client device (e.g., one of the client devices 110a-110n) generates, edits, manages, and/or stores vector graphics documents and layer lists. For example, in some instances, a client device sends a vector graphics document (e.g., a vector image) to the document viewing system 104 hosted on the server(s) 102 via the network 108. The document viewing system 104 stores the vector graphics document for later access and/or modification by one or more client devices (e.g., the client devices 110a-110n). The document viewing system 104 also provides various options to edit the vector graphics document, store the vector graphics document, and/or subsequently search for, access, and view the vector graphics document.

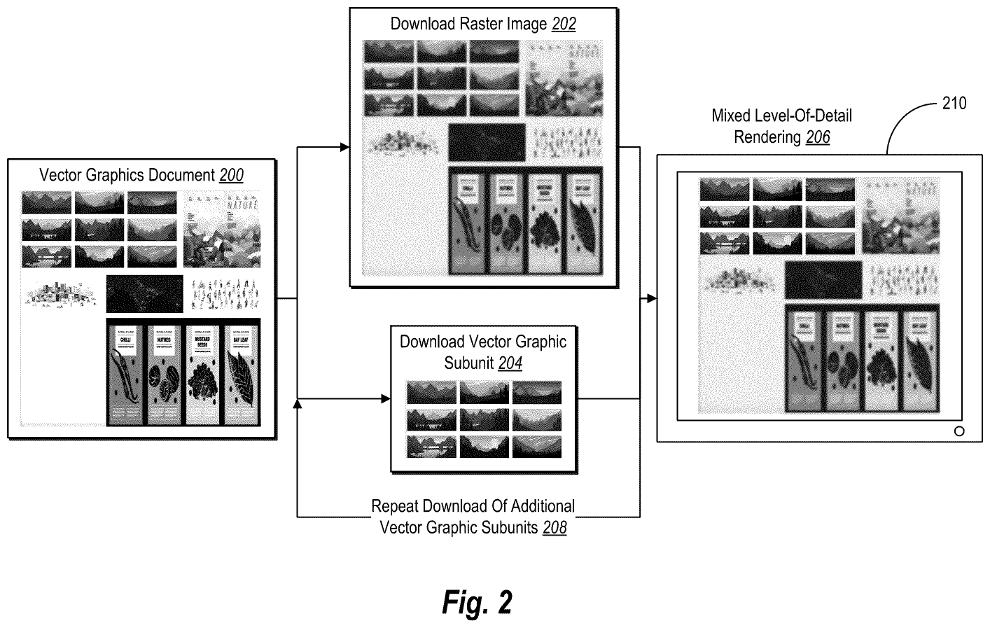

In one or more embodiments, the document viewing system 104 utilizes the mixed detail rendering system 106 to provide a mixed level-of-detail rendering of a vector graphics document to one or more client devices (e.g., the client devices 110a-110n). For example, the mixed detail rendering system 106 selects a priority graphic design layout boundary, downloads the corresponding vector graphic subunit, and provides the vector graphic subunit with a raster image of the vector graphics document while downloading additional vector graphics documents. To illustrate, as discussed in further detail below with respect to FIGS. 2-11, the mixed detail rendering system 106 generates a masked raster image of the vector graphics document with a mask corresponding to the graphic design layout boundary, clips the downloaded vector graphic subunit to the graphic design layout boundary, and provides the clipped vector graphic subunit as an overlay of the masked raster image for display via a client device. Additionally, in one or more embodiments, the server(s) 102 generate a mixed level-of-detail rendering of a vector graphics document at a first client device (e.g., client device 110a) and provide the mixed level-of-detail rendering for display at a second client device (e.g., client device 110n).

In one or more embodiments, the client devices 110a-110n include computing devices that display and/or modify vector graphics documents. For example, the client devices 110a-110n include one or more of smartphones, tablets, desktop computers, laptop computers, head-mounted-display devices, and/or other electronic devices. In some instances, the client devices 110a-110n include one or more applications (e.g., the client application 112) that display and/or modify vector graphics documents. For example, in one or more embodiments, the client application 112 includes a software application installed on the client devices 110a-110n for generating, viewing, or editing vector graphics documents. In additional embodiments, the client application 112 includes a web browser or other application that accesses a software application hosted on the server(s) 102 (and supported by the document viewing system 104).

In one or more embodiments, the mixed detail rendering system 106 and/or the document viewing system 104 on the server(s) 102 supports the mixed detail rendering system 106 on the client device 110n. For instance, in some cases, the server(s) 102 generates or otherwise provides the mixed detail rendering system 106 for a client device (e.g., the client device 110n). The server(s) 102 provides the mixed detail rendering system 106 to the client device 110n for generating and providing mixed level-of-detail renderings of vector graphics documents at the client device 110n. In other words, the client device 110n obtains (e.g., downloads) the mixed detail rendering system 106 from the server(s) 102. Once downloaded, the client device 110n utilizes the mixed detail rendering system 106 to render a vector graphics document vector graphic subunit by vector graphic subunit in parallel with downloading the vector graphics document independently from the server(s) 102.

In additional embodiments, although FIG. 1 illustrates the server(s) 102 and the client devices 110a-110n communicating via the network 108, the various components of the system environment 100 communicate and/or interact via other methods (e.g., the server(s) 102 and the client devices 110a-110n communicate directly). Furthermore, although FIG. 1 illustrates the mixed detail rendering system 106 being implemented by a particular component and/or device within the system environment 100, the mixed detail rendering system 106 is implemented, in whole or in part, by other computing devices and/or components in the system environment 100. For example, in some embodiments, the server(s) 102 include or host the document viewing system 104 and/or the mixed detail rendering system 106.

To illustrate, the mixed detail rendering system 106 includes a web hosting application that allows a client device (e.g., the client device 110n) to interact with content and services hosted on the server(s) 102. For example, in one or more implementations, the client device 110n accesses a software application (e.g., a web page) supported by the server(s) 102. In response, the mixed detail rendering system 106 on the server(s) 102 performs operations for downloading and rendering of a mixed level-of-detail rendering of a vector graphics document. The server(s) 102 then provides output or results of the operations to the client device 110n for display.

In one or more embodiments, the server(s) 102 include a variety of computing devices, including those described below with reference to FIG. 12. For example, the server(s) 102 include one or more servers for storing and processing data associated with vector graphics documents. In some embodiments, the server(s) 102 also include a plurality of computing devices in communication with each other, such as in a distributed storage environment. In some embodiments, the server(s) 102 include a content server. The server(s) 102 also optionally includes an application server, a communication server, a web-hosting server, a social networking server, a digital content campaign server, or a digital communication management server.

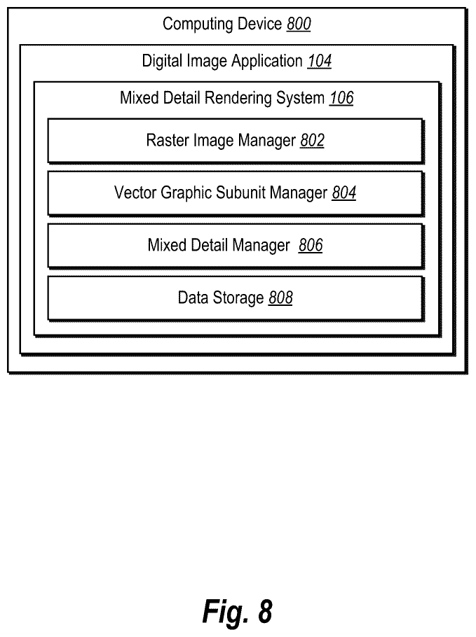

Indeed, the mixed detail rendering system 106 is able to be implemented in whole, or in part, by the individual elements of the system environment 100. Indeed, although FIG. 1 illustrates the mixed detail rendering system 106 implemented with regard to the server(s) 102, different components of the mixed detail rendering system 106 are able to be implemented by a variety of devices within the system environment 100. For example, one or more (or all) components of the mixed detail rendering system 106 are implemented by a different computing device (e.g., one of the client devices 110a-110n) or a separate server from the server(s) 102 hosting the document viewing system 104. Indeed, as shown in FIG. 1, the client devices 110a-110n include the mixed detail rendering system 106. Example components of the mixed detail rendering system 106 will be described below with regard to FIG. 8.

Additionally, as shown in FIG. 1, the system environment 100 includes the network 108. The network 108 enables communication between components of the system environment 100. In one or more embodiments, the network 108 may include the Internet or World Wide Web. Additionally, the network 108 optionally includes various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server(s) 102 and the client devices 110a-110n communicate via the network using one or more communication platforms and technologies suitable for transporting data and/or communication signals, including any known communication technologies, devices, media, and protocols supportive of data communications, examples of which are described with reference to FIG. 12.

In one or more embodiments, a vector graphics document includes a file, collection of files, digital image, or other digital representation that includes vector graphics. Specifically, a vector graphics document includes an application file that defines vector graphics (e.g., defining paths (e.g., curves or lines) for creating a graphical/visual design). Moreover, vector graphics include parameters describing properties of a path including, for example, path thickness, path pattern, and/or path color. Furthermore, in some implementations, the vector graphics documents are stored in a composite format (e.g., in a group of separate files that combine to produce one or more vector images together within a digital image application).

As previously mentioned, in some implementations, the mixed detail rendering system 106 provides a mixed level-of-detail rendering of a vector graphics document for display and modification while downloading and rendering the full vector graphics document. For example, FIG. 2 illustrates a process flow of generating a mixed level-of-detail rendering from a raster image and a vector graphic subunit.

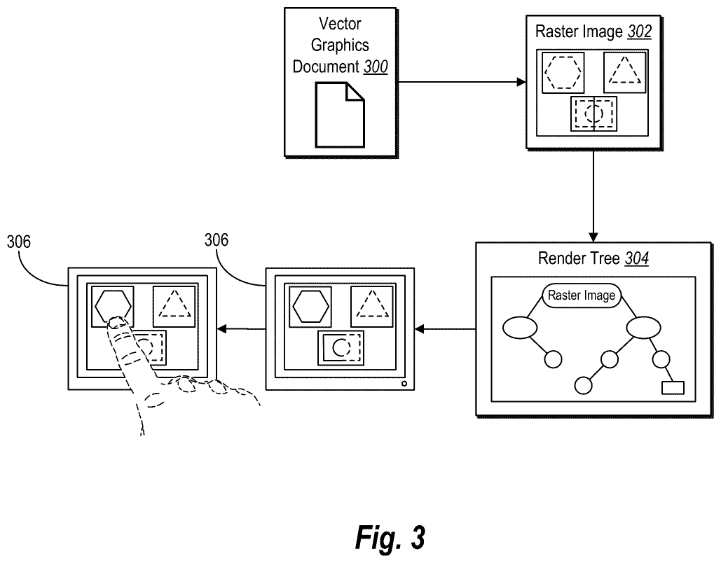

As illustrated in FIG. 2, in one or more embodiments, the mixed detail rendering system 106 renders a raster image of the vector graphics document 200 in response to a request to load the vector graphics document 200. Specifically, in response to a user interaction on a client device 210 to load the vector graphics document 200, the mixed detail rendering system 106 performs the action 202 of downloading the raster image and providing the raster image for display on the client device 210 as further discussed with respect to FIG. 3.

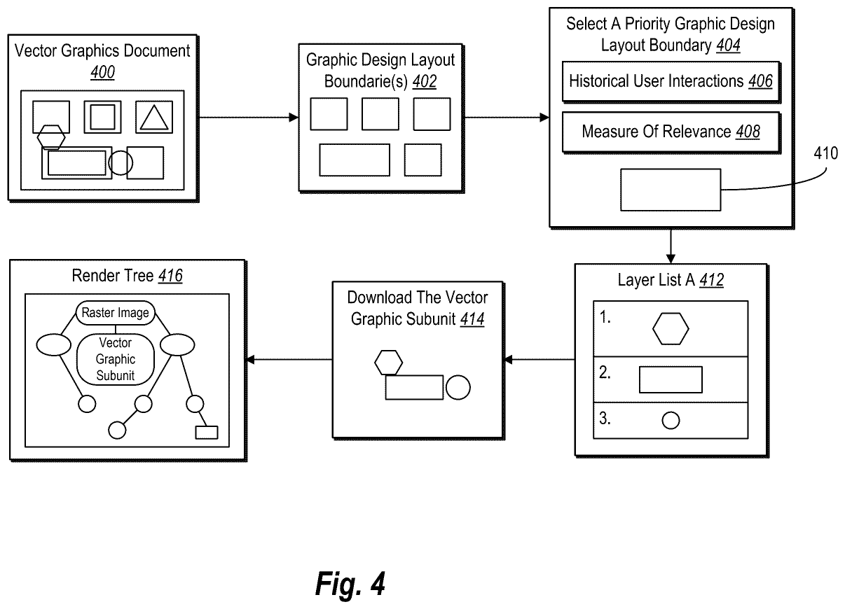

As further illustrated in FIG. 2, in one or more implementations, the mixed detail rendering system 106 performs an act 204 of downloading a vector graphic subunit. In particular, the mixed detail rendering system 106 selects the vector graphic subunit from among a plurality of vector graphic subunits of the vector graphics document 200. For example, the mixed detail rendering system 106 selects the vector graphic subunit that corresponds to a priority graphic design layout boundary as discussed further with respect to FIG. 4.

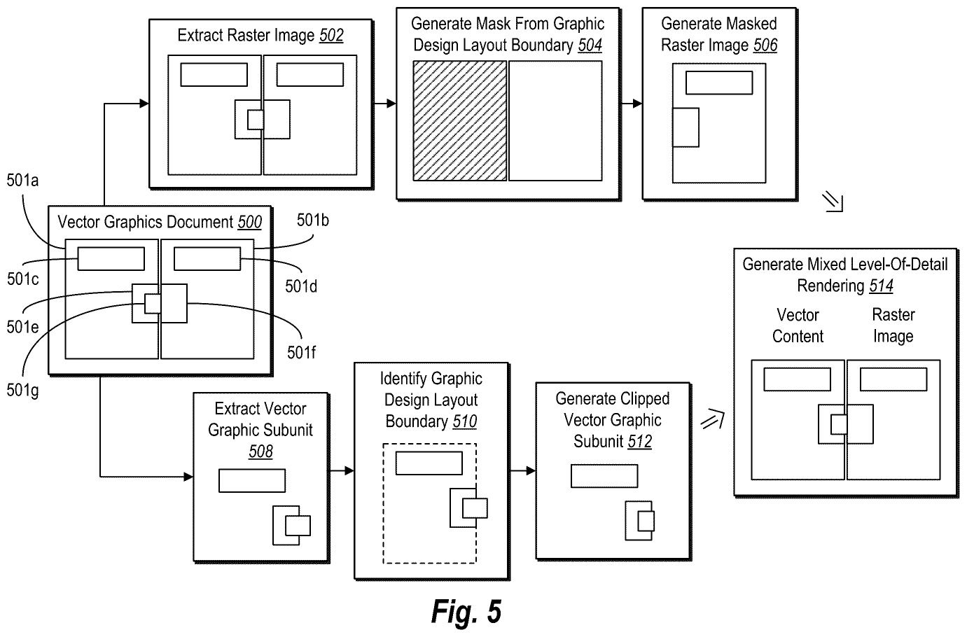

As additionally shown in FIG. 2, in some embodiments, the mixed detail rendering system 106 generates and provides a mixed level-of-detail rendering 206 of the vector graphics document 200 for display on the client device 210 as discussed in further detail with respect to FIG. 5. Specifically, the mixed detail rendering system 106 generates a masked raster image of the vector graphics document 200 using a mask corresponding to the priority graphic design layout boundary. Further, in some implementations, the mixed detail rendering system 106 provides the downloaded vector graphic subunit as an overlay of the masked raster image to provide the mixed level-of-detail rendering 206. In one or more embodiments, the mixed detail rendering system 106 generates a clipped vector graphic subunit by applying the graphic design layout boundary to the vector graphic subunit when providing the vector graphic subunit as an overlay of the masked raster image.

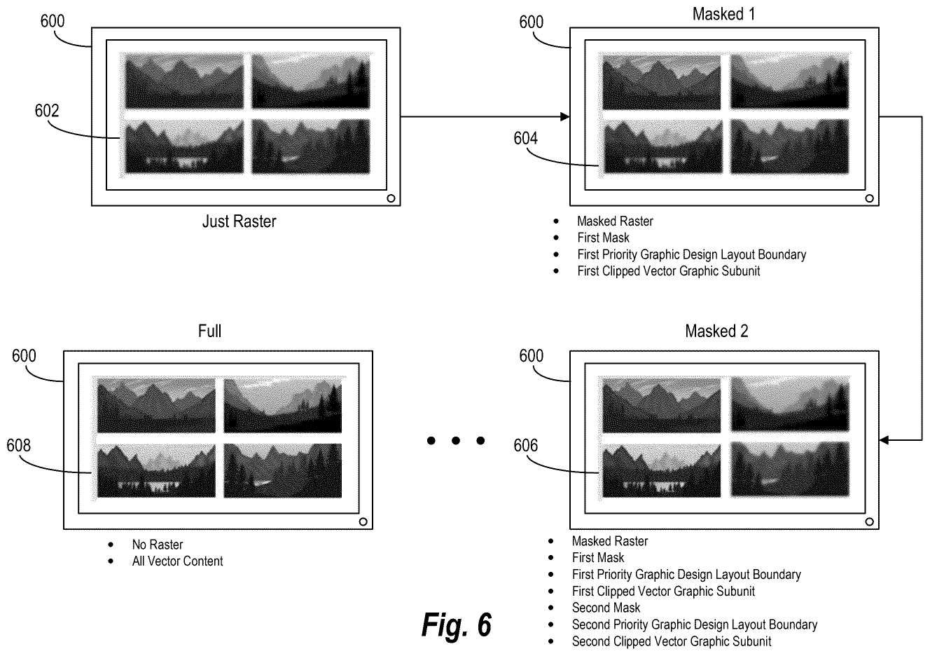

As further illustrated in FIG. 2, in one or more implementations, the mixed detail rendering system 106 performs an act 208 of repeating download of additional vector graphic subunits as discussed further with respect to FIG. 6. For instance, the mixed detail rendering system 106 determines an additional priority graphic design layout boundary of the vector graphics document 200 and determines the corresponding vector graphic subunit. Moreover, in these or other embodiments, the mixed detail rendering system 106 downloads the additional vector graphic subunit and provides both vector graphic subunits as overlays of the raster image. For instance, the mixed detail rendering system 106 generates the masked raster image using a first mask that correspond to the first graphic design layout boundary and a second mask that corresponds to the additional graphic design layout boundary. Furthermore, in some embodiments, the mixed detail rendering system 106 continues to perform the act 208 of repeating downloads of additional vector graphic subunits until the raster image has been completely replaced by the vector graphic subunits of the vector graphics document 200.

As previously noted, in some implementations, the mixed detail rendering system 106 renders a raster image of the vector graphics document in response to a request to load the vector graphics document. Indeed, in one or more embodiments, the mixed detail rendering system 106 renders the raster image with downloaded vector graphics subunits to generate a mixed level-of-detail rendering. FIG. 3 illustrates a process flow of generating a mixed level-of-detail rendering utilizing a raster image in accordance with one or more embodiments.

As shown in FIG. 3, in one or more implementations, the mixed detail rendering system 106 downloads a raster image 302 of a vector graphics document 300 in response to a request to load the vector graphics document 300. For example, in response to a request to load the vector graphics document 300 at a client device 306, the mixed detail rendering system 106 downloads a raster image 302 of the vector graphics document 300. As used herein, the term “raster image” refers to a digital image defined by pixels. For instance, a raster image includes a digital image that includes a fixed grid of pixels, where each pixel represents a specific color. In some embodiments, a raster image is resolution-dependent, meaning the clarity is defined by the number of pixels per inch. For instance, in some implementations, a raster images includes a web graphic, a digital snapshot, a digital painting, etc., which are saved in formats including JPEG, PNG, GIF, etc. In one or more embodiments, the mixed detail rendering system 106 loads metadata of the vector graphics document including a manifest. Additionally, in these or other embodiments, the manifest includes graphic design layout boundaries and corresponding layer lists which the mixed detail rendering system 106 utilizes when selecting the vector graphic subunit as described below with respect to FIG. 4.

To illustrate, the downloaded raster image 302 includes a representation of vector graphics by showing objects (i.e., a hexagon, a triangle, a rectangle and a circle) in a dashed line format representing that the objects are in the low-resolution, raster format. Thus, an attempt to zoom in and/or expand the raster image 302 at a client device would result in a pixelated (or low-resolution) appearance. Further, in one or more implementations, the raster image 302 includes a full content rendition of the vector graphics document 300 at a selected resolution (e.g., at 2048 pixels by 2048 pixels). Moreover, in some embodiments, the mixed detail rendering system 106 generates the raster image 302 in response to receiving a user interaction to save the vector graphics document 300.

As also depicted in FIG. 3, in some implementations, the mixed detail rendering system 106 renders the raster image 302 for display on the client device 306 by attaching the raster image 302 to a render tree 304 of the vector graphics document 300. In particular, the mixed detail rendering system 106 attaches the downloaded raster image 302 as a backdrop on the render tree of the vector graphics document 300. Furthermore, in one or more embodiments, the mixed detail rendering system 106 provides a mixed level-of-detail rendering of the vector graphics document 300 by providing the raster image 302 with one or more downloaded vector graphics subunits to the client device 306.

As mentioned above, and as further illustrated in FIG. 3, the mixed detail rendering system 106 provides the raster image 302 with one or more downloaded vector graphic subunits to the client device 306 to provide the mixed level-of-detail rendering. As used herein, the term “mixed level-of-detail rendering” refers to a rendering of a digital document (e.g., a vector graphics document) including a raster image portion and a vector graphics portion. Specifically, a mixed level-of-detail rendering includes a raster image portion and one or more vector graphic subunits rendered with the raster image. For example, a mixed level-of-detail rendering includes a raster image rendered as a backdrop and vector graphic subunits rendered as overlays of the raster image.

To illustrate, the mixed detail rendering system 106 provides the raster image 302, shown with dashed lines, at the client device 306 with a downloaded vector graphic subunit shown with solid lines. For example, the mixed detail rendering system 106 provides the raster image 302 as a portion of the mixed level-of-detail rendering wherein the raster image portion includes the triangle, half of the rectangle, and half of the circle. Additionally, in these or other embodiments, the mixed detail rendering system 106 provides the downloaded vector graphic subunit wherein the vector graphic subunit includes the hexagon, half of the rectangle, and half of the circle (shown with solid lines).

As additionally shown in FIG. 3, in one or more implementations, the mixed detail rendering system 106 provides the mixed level-of-detail rendering comprising the raster image 302 and the downloaded vector graphic subunit such that the client device 306 can modify the vector graphic subunit. For example, the client device 306 can modify the vector content of the vector graphic subunit while the raster image portion of the mixed level-of-detail rendering remains visible. As used herein, the term “vector content” refers to editable content of the vector graphics document. For example, in some embodiments, vector content refers to the graphical elements contained within a vector graphics file that are defined using mathematical expressions such as points, lines, and curves (as opposed to being defined by pixels, as in a raster image). In particular, vector content encompasses shapes, paths, text, images, gradients, patterns, and metadata, all organized using graphic layers, groups, artboards, etc. for efficient management and manipulation. For instance, vector content in a vector graphics document includes editable text objects, reusable symbols, compound paths, gradients, clipping paths, and guides, allowing for the creation of scalable, detailed designs suitable for various media.

As noted above, in some implementations, the mixed detail rendering system 106 downloads a vector graphic subunit for display as an overlay of the raster image. For example, the mixed detail rendering system 106 identifies a priority graphic design layout boundary and the associated vector graphic subunit and attaches the vector graphic subunit to the render tree for display with the raster image. FIG. 4 illustrates a process flow of identifying and providing a vector graphic subunit for display in accordance with one or more embodiments.

As portrayed in FIG. 4, in one or more embodiments, the mixed detail rendering system 106 identifies a plurality of graphic design layout boundaries 402 within a vector graphics document 400. As used herein, the term “graphic design layout boundary” refers to a defined workspace within a digital design application and/or vector graphics document. Indeed, in one or more implementations, a graphic design layout boundary represents a printable or exportable area for a particular design project. In particular, the mixed detail rendering system 106 utilizes a graphic design layout boundary to organize, preview, and export different parts of a digital design within a single vector graphics document. For instance, in some embodiments, a graphic design layout boundary includes an artboard, a page, a slide, a frame, a canvas, or other defined workspace (or a boundary within a threshold distance of these items).

As further illustrated in FIG. 4, in some implementations, the mixed detail rendering system 106 performs an act 404 of selecting a priority graphic design layout boundary 410. In some implementations, the mixed detail rendering system 106 selects a priority graphic design layout boundary 410 from the plurality of graphic design layout boundaries 402 of the vector graphics document 400 as described in U.S. application Ser. No. 18/538,186, filed Dec. 13, 2023, entitled RENDERING DIGITAL VECTOR FILES WITH PRIORITIZED AND INCREMENTAL DOWNLOAD, the contents of which are herein incorporated by reference in their entirety. For instance, the mixed detail rendering system 106 utilizes a variety of factors relating to the client device and the environment in which the client device operates. To illustrate, in one or more embodiments, the mixed detail rendering system 106 determines the priority graphic design layout boundary 410 by determining the capability of client factors such as available memory, processing speed, operating system, disk space, bus speed, etc. Additionally, or alternatively, the mixed detail rendering system 106 determines factors relating to the environment in which the client device operates such as download speeds of an internet connection, intermittency of an internet connection, etc. to determine the priority graphic design layout boundary 410.

Further, in one or more implementations, the mixed detail rendering system 106 utilizes priority information of the vector graphics document 400 to select the priority graphic design layout boundary 410. For example, the mixed detail rendering system 106 determines historical user interactions 406 with vector content of the vector graphics document 400 to select the priority graphic design layout boundary 410. In some embodiments, historical user interactions include user interactions with the vector content of the graphic design layout boundaries 402 from a previous session with a vector graphics document in the document viewing system or in a client application or user interactions from an earlier point in time in a current session. For example, the mixed detail rendering system 106 determines historical user interactions 406 such as the most recent user interactions, the most frequent user interactions, or other interactions with the vector content within the various graphic design layout boundaries 402.

As just mentioned, in some implementations, the mixed detail rendering system 106 identifies the priority graphic design layout boundary 410 based on historical user interactions 406 with the vector content. Specifically, in one or more embodiments, the mixed detail rendering system 106 compares historical user interactions across the graphic design layout boundaries within the vector graphics document. For example, the mixed detail rendering system 106 compares user interactions with vector content within the graphic design layout boundaries 402 of the vector graphics document 400. To illustrate, the mixed detail rendering system 106 identifies a graphic design layout boundary with the most frequent user interactions from a previous session with the vector graphics document 400 on a client device and identifies this graphic design layout boundary as the priority graphic design layout boundary 410.

Moreover, in one or more implementations, the mixed detail rendering system 106 uses priority information of the vector graphics document 400 such as a measure of relevance 408 to select the priority graphic design layout boundary 410. For example, the mixed detail rendering system 106 determines a measure of relevance between vector content within the graphic design layout boundaries 402 and a user of the client device. The mixed detail rendering system 106 can determine a measure of relevance utilizing a variety of algorithms. For example, the mixed detail rendering system 106 can determine a measure of relevance utilizing a heuristic model (e.g., graphic design layout boundary that is a threshold distance from a point in the graphic design document or a graphic design layout boundary that was selected within a threshold period of time) and/or a trained machine learning model (e.g., a model trained based on monitored selection or interaction with graphic design layout boundaries).

The mixed detail rendering system 106 can determine a measure of relevance based on a variety of features or factors including historical interactions, user preferences, or spatial arrangement. For example, the mixed detail rendering system 106 determines a measure of relevance from ongoing user interactions with portions of a downloaded vector graphic subunit or the raster image as displayed on the client device. Furthermore, in these or other embodiments, the mixed detail rendering system 106 selects the priority graphic design layout boundary 410 based on the measure of relevance between the vector content within the priority graphic design layout boundary 410 and the user of the client device.

To illustrate, the mixed detail rendering system 106 determines user interactions with vector content of a downloaded graphic design layout boundary and/or nearby portions of the raster image. In these or other embodiments, the mixed detail rendering system 106 selects the priority graphic design layout boundary 410 as a graphic design layout boundary adjacent to the downloaded graphic design layout boundary and/or a graphic design layout boundary corresponding to the nearby portions of the raster image. In some implementations, the mixed detail rendering system 106 determines the measure of relevance based on spatial arrangement (e.g., selecting graphic design layout boundaries that are closest to the center or another visually relevant location within a graphic design document).

As also depicted in FIG. 4, in some embodiments, the mixed detail rendering system 106 utilizes a layer list to identify a vector graphic subunit associated with the priority graphic design layout boundary 410. As used herein, the term “layer list” refers to a list of components of a vector graphics document. In particular, a layer list includes layers or labels assigned to vector graphics of a graphic layer that fall within a graphic design layout boundary. For example, in some implementations, the mixed detail rendering system 106 generates a layer list for each graphic design layout boundary including all of the vector graphics within the graphic design layout boundary organized by graphic layer. In particular, a layer list includes the graphic layers in a specific order to preserve a rendering order (or z-order) of the graphic layers and corresponding graphic vectors. Relatedly, the term “vector graphic subunit” refers to a subset of vector graphics within a vector graphics document. In particular, a vector graphic subunit includes vector graphics that are within a designated area of the vector graphics document. For example, in one or more embodiments, a vector graphic subunit includes a subset of vector graphics that are within a graphic design layout boundary, within multiple graphic design layout boundaries, or otherwise includes vector graphics determined using a designated area of the vector graphics document, whether the area is contiguous or not.

As mentioned previously, in one or more implementations, the mixed detail rendering system 106 utilizes a layer list to identify a vector graphic subunit associated with the priority graphic design layout boundary 410 for download. Specifically, in some embodiments, the mixed detail rendering system 106 determines graphic layers of the vector graphics document 400 that fall within the priority graphic design layout boundary 410. A graphic layer, as used herein, refers to an organizational unit with a vector graphics document. In particular, a graphic layer includes a label or group assigned to vector graphics such that the mixed detail rendering system 106 is capable of arranging and managing the vector graphics of one layer independently of another. Relatedly, a vector graphic refers to shapes, text, images, and other visual elements of a vector graphics document. In particular, a vector graphic is defined by mathematical equations indicating paths (e.g., curves or lines) describing properties of a path including, for example, path thickness, path pattern, and/or path color.

As noted previously, in some implementations, the mixed detail rendering system 106 determines which graphic layers of the vector graphics documents 400 fall within the priority graphic design layout boundary 410. Additionally, in one or more embodiments, the mixed detail rendering system 106 utilizes these graphic layers to generate the layer list A 412. Further, in these or other embodiments, the mixed detail rendering system 106 utilizes the layer list A 412 to identify a vector graphic subunit associated with the priority graphic design layout boundary 410.

To illustrate, the mixed detail rendering system 106 generates the layer list A 412 for the priority graphic design layout boundary 410 using the plurality of graphic layers of the vector graphics document 400. In this example, the mixed detail rendering system 106 identifies that three layers fall within the priority graphic design layout boundary 410 (i.e., layers 1-3 of layer list A 412). Moreover, in this example, the mixed detail rendering system 106 determines that each of these three layers include vector graphics that fall within the priority graphic design layout boundary 410. For example, the mixed detail rendering system 106 identifies that layers 1-3 include a hexagon, a rectangle, and a circle, each falling within the priority graphic design layout boundary 410 respectively as shown in the vector graphics document 400.

As further illustrated in FIG. 4, in one or more implementations, the mixed detail rendering system 106 selects the vector graphic subunit based on the graphic layers of the vector graphics document. In particular, the mixed detail rendering system 106 utilizes the layer list A 412 generated from the graphic layers to select the vector graphic subunit. In this example, the mixed detail rendering system 106 selects the vector graphics within the boundary of the priority graphic design layout boundary 410 (i.e., the hexagon, the rectangle, and the circle) as the vector graphic subunit for download.

As additionally shown in FIG. 4, in some embodiments, the mixed detail rendering system 106 performs an act 414 of downloading the vector graphic subunit for rendering. Specifically, the mixed detail rendering system 106 downloads the vector graphic subunit and attaches the vector graphic subunit to the render tree 416. In some implementations, the mixed detail rendering system 106 performs the foregoing acts to provide the vector graphic subunit for display via the client device as an overlay to the raster image. Furthermore, in one or more embodiments, the mixed detail rendering system 106 performs additional actions on the raster image and the vector graphic subunit (e.g., in the render tree 416) to provide the mixed level-of-detail rendering for display on a client device as discussed in detail with respect to FIG. 5.

As previously mentioned, in one or more implementations, the mixed detail rendering system 106 generates and provides a mixed level-of-detail rendering of the vector graphics document. For instance, in some embodiments, the mixed detail rendering system 106 generates a masked raster image and a clipped vector graphic subunit to generate the mixed level-of-detail rendering. FIG. 5 illustrates a process flow of generating and providing for display a mixed level-of-detail rendering in accordance with one or more embodiments.

As depicted in FIG. 5, in some implementations, the mixed detail rendering system 106 extracts a raster image 502 from the vector graphics document 500. To illustrate, the vector graphics document 500 includes a left (501a) and right (501b) graphic design layout boundary, each encompassing vector graphics including a top rectangle (501c and 501d) and a large, center rectangle (501e and 501f). Additionally, the left graphic design layout boundary 501a also encompasses a portion of a vector graphic that is a small, center rectangle 501g. As previously noted, the mixed detail rendering system 106 generates the raster image 502 from the vector graphics document 500 such that all of these vector graphics of the right and left graphic design layout boundaries are represented in the raster image 502.

As further illustrated in FIG. 5, in one or more embodiments, the mixed detail rendering system 106 performs an act 504 of generating a mask from the graphic design layout boundary. Specifically, the mixed detail rendering system 106 generates a mask corresponding a priority graphic design layout boundary selected as described above with respect to FIG. 4. To illustrate, the mixed detail rendering system 106 generates a mask corresponding to the left graphic design layout boundary as shown in the act 504. As used herein, the term “mask” refers to a shape or path used to control the visibility of vector graphics in vector graphic documents (and/or pixels in a raster image). In one or more implementations, a mask defines which parts of a vector graphic and/or raster image are visible or hidden. For instance, in some embodiments, a mask includes an opacity mask that fades a vector graphic or raster image into different levels of opacity (e.g., up to complete opacity) or a clipping mask that confines a vector graphic to a specific shape or to a boundary line of another graphic element such as a graphic design layout boundary, etc.

As also depicted in FIG. 5, in some implementations, the mixed detail rendering system 106 performs an act 506 of generating a masked raster image. Specifically, the mixed detail rendering system 106 generates the masked raster image by applying the mask corresponding the priority graphic design layout boundary to the raster image 502. To illustrate, the mixed detail rendering system 106 applies the mask corresponding to the left graphic design layout boundary to the raster image 502. For example, in these or other embodiments, the mixed detail rendering system 106 applies a mask covering the portion of the raster image 502 corresponding to the left graphic design layout boundary. Accordingly, in one or more embodiments, the act 506 of generating the masked raster image results in a masked raster image wherein only raster representations of the right graphic design layout boundary and corresponding vector graphics are visible in the raster image when displayed on a client device. In one or more implementations, the mixed detail rendering system 106 generates the mask and applies the mask to the raster image 502 to generate the masked raster image in the render tree. Indeed, in these or other embodiments, the mixed detail rendering system 106 adds the mask on top of the backdrop (e.g., when the mixed detail rendering system 106 attaches the raster image as the backdrop) in the render tree.

As further illustrated in FIG. 5, in some embodiments, the mixed detail rendering system 106 performs an act 508 of extracting a vector graphic subunit. Specifically, the mixed detail rendering system 106 determines the vector graphic subunit corresponding to the priority graphic design layout boundary as described above with respect to FIG. 4. Further, in some implementations, the mixed detail rendering system 106 extracts the vector graphic subunit, for example, by downloading the vector graphic subunit. Additionally, in one or more embodiments, the mixed detail rendering system 106 further provides the vector graphic subunit to the render tree.

As additionally shown in FIG. 5, in one or more implementations, the mixed detail rendering system 106 performs an act 510 of identifying the graphic design layout boundary. Specifically, the mixed detail rendering system 106 identifies the graphic design layout boundary used to generate the mask in the act 504. For example, the mixed detail rendering system 106 identifies the graphic design layout boundary by selecting the priority graphic design layout boundary as described above with respect to FIG. 4. To illustrate, the mixed detail rendering system 106 identifies the left graphic design layout boundary of the vector graphics document 500. As shown in an act 510, in this example, portions of the vector graphic subunit (i.e., portions of the small, center rectangle) extend beyond the left graphic design layout boundary (shown with a dashed line).

As further illustrated in FIG. 5, in some embodiments, the mixed detail rendering system 106 performs an act 512 of generating a clipped vector graphic subunit. In particular, the mixed detail rendering system 106 generates the clipped vector graphic subunit by applying the priority graphic design layout boundary to the vector graphic subunit. To illustrate, the mixed detail rendering system 106 applies the left graphic design layout boundary identified in the act 510 to the vector graphic subunit extracted in the act 508 to generate the clipped vector graphic subunit as shown in the act 512. In some implementations, the mixed detail rendering system 106 attaches the vector graphic subunit to the render tree and generates the clipped vector graphic subunit within the render tree.

As also depicted in FIG. 5, in one or more embodiments, the mixed detail rendering system 106 performs the act 514 of generating the mixed level-of-detail rendering. Specifically, the mixed detail rendering system 106 generates the mixed level-of-detail rendering by combining the masked raster image and the clipped vector graphic subunit. For example, the mixed detail rendering system 106 provides the clipped vector graphic subunit as an overlay of the masked raster image. In other words, the mixed detail rendering system 106 provides the clipped vector graphic subunit over the masked raster image. Moreover, in one or more implementations, the mixed detail rendering system 106 provides the mixed level-of-detail rendering for display via a client device as described in more detail with respect to FIG. 6. In some embodiments, the mixed detail rendering system 106 provides the vector graphic subunit as an overlay of the masked raster image from the render tree.

Furthermore, in some implementations, the mixed detail rendering system 106 determines a rendering order of the vector graphics of the vector graphic subunit. Specifically, the mixed detail rendering system 106 determines the rendering order based on a layer list of the vector graphics document. In these or other embodiments, the mixed detail rendering system 106 utilizes the indices of the graphic layers in the layer list to determine the rendering order. For example, when providing a clipped vector graphic subunit as an overlay of a masked raster image, the mixed detail rendering system 106 utilizes the layer list of the priority graphic design layout boundary to determine the rendering order of the vector graphics in different graphic layers. Additionally, in one or more embodiments, the mixed detail rendering system 106 provides the vector graphics of the vector graphic subunit for display at a client device according to the rendering order.

To illustrate, the mixed detail rendering system 106 utilizes a layer list of the left graphic design layout boundary to determine the rendering order of the vector graphics of the clipped vector graphic subunit (i.e., the top rectangle 501c, the large, center rectangle 501e, and the small, center rectangle 501g). Accordingly, the mixed detail rendering system 106 properly renders the small, center rectangle 501g in front of the large, center rectangle 501e in the mixed level-of-detail rendering regardless of whether these vector graphics are in separate layers such that the mixed level-of-detail rendering matches the vector graphics document 500.

As mentioned above, in one or more implementations, the mixed detail rendering system 106 repeatedly selects and downloads additional vector graphic subunits for display with the raster image. For example, the mixed detail rendering system 106 repeats this process until the raster portions of the mixed level-of-detail rendering are completely replaced with the full vector graphics document. FIG. 6 illustrates a process flow of repeatedly selecting and downloading vector graphic subunits for display as part of the mixed level-of-detail rendering in accordance with one or more embodiments.

As illustrated in FIG. 6, in some embodiments, the mixed detail rendering system 106 generates and provides a raster image 602 for display on a client device 600. Specifically, the mixed detail rendering system 106 generates and provides the raster image 602 for display on the client device 600 as described above with respect to FIG. 3.

As further illustrated in FIG. 6, in some implementations, the mixed detail rendering system 106 generates and provides a first mixed level-of-detail rendering 604 for display on the client device 600. In particular, the mixed detail rendering system 106 generates and provides the first mixed level-of-detail rendering 604 for display via the client device 600 as described above with respect to FIGS. 2-5. For instance, the mixed detail rendering system 106 identifies a first priority graphic design layout boundary as described above. Further, in one or more embodiments, the mixed detail rendering system 106 generates a first mask corresponding to the first graphic design layout boundary and generates a first masked raster image using the first mask. Moreover, in one or more implementations, the mixed detail rendering system 106 selects a first vector graphic subunit of the vector graphics document to download using the first priority graphic design layout boundary and clips the first vector graphics subunit to the first priority graphic design layout boundary as described above. Furthermore, in these or other embodiments, the mixed detail rendering system 106 provides the first vector graphic subunit (as clipped) with the first masked raster image to provide the first mixed level-of-detail rendering 604 for display on the client device 600.

To illustrate, the mixed detail rendering system 106 selects the first priority graphic design layout boundary corresponding to the image in the top left quarter of the raster image 602. Additionally, the mixed detail rendering system 106 then performs the acts as described in the foregoing paragraph to provide the first mixed level-of-detail rendering 604 with the first vector graphic subunit as an overlay of the first masked raster image. Accordingly, as shown in FIG. 6, the mixed detail rendering system 106 renders the first vector graphic subunit in the top left quarter of the first mixed level-of-detail rendering 604 as an overlay of the first masked raster image. Further, in these or other embodiments, the mixed detail rendering system 106 provides the first vector graphic subunit such that the client device 600 can modify the first vector graphic subunit while the mixed detail rendering system 106 continues downloading an additional vector graphic subunit. Indeed, in some embodiments, the mixed detail rendering system 106 provides the first mixed level-of-detail rendering 604 such that the client device can perform various operations on the first vector graphic subunit such as allowing the client device to pan or zoom, utilize artboard navigations, comment/annotate, edit vector content, etc.

As additionally shown in FIG. 6, in some implementations, the mixed detail rendering system 106 generates and provides a second mixed level-of-detail rendering 606 for display on the client device 600 using similar methods and acts as described above with respect to FIGS. 2-5. For instance, the mixed detail rendering system 106 identifies a second priority graphic design layout boundary for download while providing the first mixed level-of-detail rendering 604. Moreover, in one or more embodiments, the mixed detail rendering system 106 generates a second mask corresponding to the second graphic design layout boundary and generates a second masked raster image using both the first and second masks. Furthermore, in one or more implementations, the mixed detail rendering system 106 selects and downloads a second vector graphic subunit of the vector graphics document using the second priority graphic design layout boundary in addition to the first vector graphic subunit. Additionally, in some embodiments, the mixed detail rendering system 106 clips the second vector graphics subunit to the second priority graphic design layout boundary as described above. Further, in these or other embodiments, the mixed detail rendering system 106 provides the first and second vector graphic subunits (as clipped) with the second masked raster image to provide the second mixed level-of-detail rendering 606 for display on the client device 600.

To illustrate, the mixed detail rendering system 106 selects the second priority graphic design layout boundary corresponding to the image in the bottom left quarter of the raster image 602. Moreover, the mixed detail rendering system 106 then performs the acts as described in the foregoing paragraph to provide the second mixed level-of-detail rendering 606 with the both the first and second vector graphic subunits as overlays of the second masked raster image. Accordingly, as shown in FIG. 6, the mixed detail rendering system 106 renders the first and second vector graphic subunits in the top and bottom left quarters, respectively, of the second mixed level-of-detail rendering 606 as overlays of the second masked raster image. Furthermore, in these or other embodiments, the mixed detail rendering system 106 provides both the first and second vector graphic subunits such that the client device 600 can modify each (as described above with respect to the first vector graphic subunit) while the mixed detail rendering system 106 continues downloading additional vector graphic subunits.

As further illustrated in FIG. 6, in some implementations, the mixed detail rendering system 106 continues to repeat the process of downloading and providing for display the vector graphic subunits of the vector graphics document as overlays of the masked raster image. In particular, the mixed detail rendering system 106 provides each downloaded vector graphic subunit as an overlay of the masked raster image with other downloaded vector graphic subunits until the mixed detail rendering system 106 completely replaces the raster image. To illustrate, the mixed detail rendering system 106 continues this process to download all of the vector content of the vector graphics document to provide the full vector graphics document 608 for display on the client device 600.

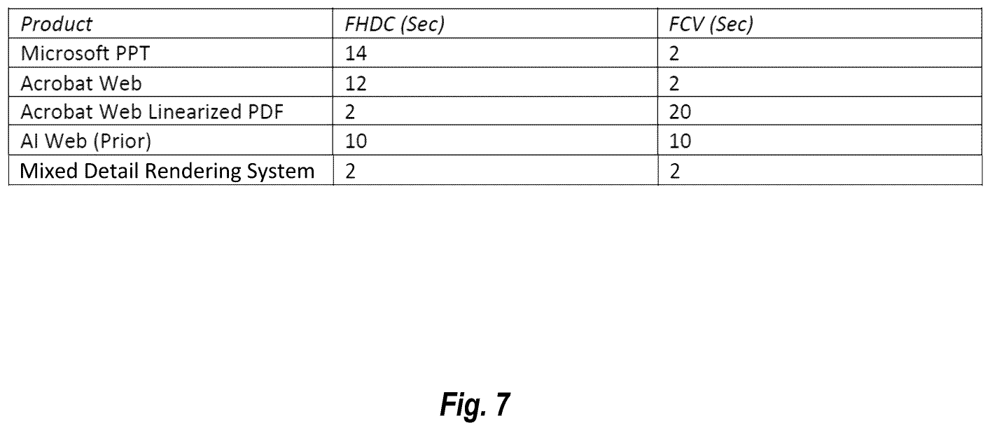

In one or more embodiments, the mixed detail rendering system 106 improves the efficiency of downloading and rendering large vector graphics documents. Indeed, in one or more implementations, the mixed detail rendering system 106 improves efficiency by freeing up computing resources by making downloaded data (e.g., vector graphic subunits) available for rendering much more quickly. FIG. 7 illustrates vector graphic rendering times achieved by the mixed detail rendering system 106 compared with example prior art vector graphic rendering times in accordance with one or more embodiments.

As shown in FIG. 7, the table compares vector graphic rendering times for various example products to those of the mixed detail rendering system 106 using two metrics. Specifically, the table illustrates a first high detail content (FHDC) metric and a full content visibility (FCV) metric for each system using the same vector graphics document (except for the Acrobat Web Linearized 918 which has been included for comparison and completeness). The FHDC refers to the time (e.g., in seconds) required to render the first high-resolution content of the vector graphics document (e.g., a vector graphic subunit in the case of the mixed detail rendering system 106). The FCV refers to the time (e.g., in seconds) required to render the entire content of a vector graphics document (e.g., as a low-resolution image/a raster image).

As also depicted in FIG. 7, in some embodiments, the mixed detail rendering system 106 achieves the fastest combination of FHDC and FCV. For example, the mixed detail rendering system 106 achieves an FHDC and FCV of 2 seconds each. Thus, the mixed detail rendering system 106 renders a first vector graphic subunit capable of being modified by the client device at the same time the mixed detail rendering system 106 renders the raster image. Thus, the mixed detail rendering system 106 achieves a five-fold speed increase over the next fastest system which only achieves an FHDC and FCV combination at 10 seconds. Additionally, in some implementations, the mixed detail rendering system 106 achieves these speeds regardless of the size and/or complexity of the vector graphics document being rendered.

Turning to FIG. 8, additional detail will now be provided regarding various components and capabilities of the mixed detail rendering system 106. In particular, FIG. 8 illustrates an example schematic diagram of a computing device 800 (e.g., the server(s) 102 and/or the client device(s) 110a-110n) implementing the mixed detail rendering system 106 in accordance with one or more embodiments of the present disclosure for components 800-808. As illustrated in FIG. 8, the mixed detail rendering system 106 includes a raster image manager 802, a vector graphic subunit manager 804, a mixed detail manager 806, and data storage 808.

The raster image manager 802 accesses one or more vector graphics documents. For example, the raster image manager 802 accesses the vector graphics document(s) and generates and/or downloads a raster image of the vector graphics document. Further, in one or more embodiments, the raster image manager 802 interacts with other components to provide the raster image for further processing, such as by attaching the raster image to a render tree of the vector graphics document.

The vector graphic subunit manager 804 selects and downloads vector graphic subunits to provide for display with the raster image. For example, the vector graphic subunit manager 804 selects a vector graphic subunit for download, for example, based on the graphic layers of the vector graphics document. In particular, the vector graphic subunit manager 804 selects a priority graphic design layout boundary based on the graphic layers (e.g., using layer lists of the graphic design layout boundaries) to select the vector graphic subunit. Moreover, in one or more implementations, the vector graphic subunit manager 804 downloads the selected vector graphic subunit. In some embodiments, the vector graphic subunit manager 804 interacts with other components to provide the vector graphic subunit for further processing, such as by attaching the vector graphic subunit to the render tree of the vector graphics document.

The mixed detail manager 806 accesses the downloaded raster image and vector graphics subunit to generate and provide the mixed level-of-detail rendering for display via a client device. For example, the mixed detail manager 806 generates a mask corresponding to the graphic design layout boundary selected by the vector graphic subunit manager 804. Furthermore, in some implementations, the mixed detail manager 806 uses the mask to generate a masked raster image by applying the mask corresponding to the priority graphic design layout boundary to the raster image. Additionally, the mixed detail manager 806 generates a clipped vector graphic subunit by applying the priority graphic design layout boundary to the vector graphic subunit. Further, the mixed detail manager 806 provides the mixed level-of-detail rendering to the client device by providing the clipped vector graphic subunit with (e.g., as an overlay of) the masked raster image.

The data storage 808 stores datasets, documents, raster images, downloaded vector graphics, masks, and layer lists. For example, the data storage 808 stores vector graphics documents accessed from various client device and/or server locations and stores corresponding raster images, layer lists, and masks. Further, the data storage 808 stores user interactions with the vector content of the vector graphics document for determining priority information such as determining a priority graphic design layout boundary.

Each of the components 802-808 of the mixed detail rendering system 106 can include software, hardware, or both. For example, the components 802-808 can include one or more instructions stored on a computer-readable storage medium and executable by processors of one or more computing devices, such as a client device or server device. When executed by the one or more processors, the computer-executable instructions of the mixed detail rendering system 106 can cause the computing device(s) to perform the methods described herein. Alternatively, the components 802-808 can include hardware, such as a special-purpose processing device to perform a certain function or group of functions. Alternatively, the components 802-808 of the mixed detail rendering system 106 can include a combination of computer-executable instructions and hardware.

Furthermore, the components 802-808 of the mixed detail rendering system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 802-808 of the mixed detail rendering system 106 may be implemented as a stand-alone application, such as a desktop or mobile application. Furthermore, the components 802-808 of the mixed detail rendering system 106 may be implemented as one or more web-based applications hosted on a remote server. Alternatively, or additionally, the components 802-808 of the mixed detail rendering system 106 may be implemented in a suite of mobile device applications or “apps.” For example, in one or more embodiments, the mixed detail rendering system 106 can comprise or operate in connection with digital software applications such as ADOBE® ILLUSTRATOR® CREATIVE CLOUD®, ADOBE® ACROBAT®, ADOBE® DOCUMENT CLOUD®, ADOBE® INDESIGN® CREATIVE CLOUD®, ADOBE® EXPRESS®, and/or ADOBE® CREATIVE CLOUD®. The foregoing are either registered trademarks or trademarks of Adobe Inc. in the United States and/or other countries.

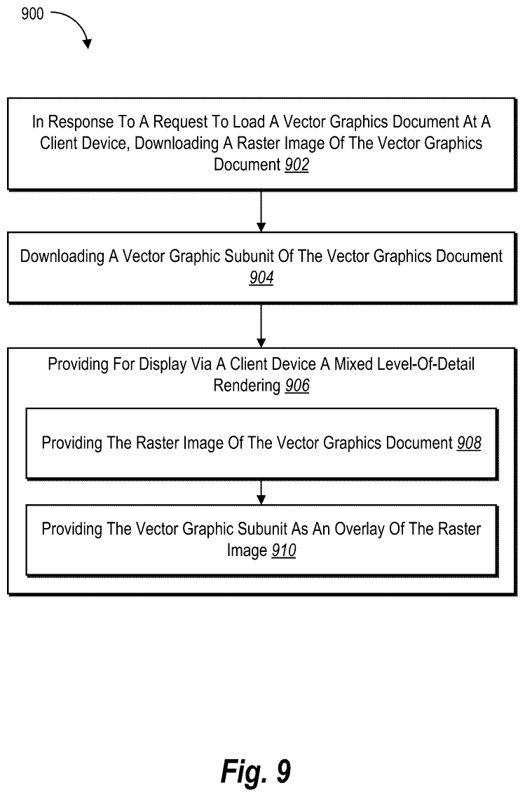

FIGS. 1-8, the corresponding text, and the examples provide a number of different systems, methods, and non-transitory computer readable media for providing a mixed level-of-detail rendering of a vector graphics document for display and modification while downloading and rendering the full vector graphics document. In addition to the foregoing, embodiments can also be described in terms of flowcharts comprising acts for accomplishing a particular result. For example, FIGS. 9-11 illustrate flowcharts of example sequences of acts in accordance with one or more embodiments.

While FIGS. 9-11 illustrate acts according to some embodiments, alternative embodiments may omit, add to, reorder, and/or modify any of the acts shown in FIGS. 9-11. The acts of FIGS. 9-11 can be performed as part of a method. Alternatively, a non-transitory computer readable medium can comprise instructions, that when executed by one or more processors, cause a computing device to perform the acts of FIGS. 9-11. In still further embodiments, a system can perform the acts of FIGS. 9-11. Additionally, the acts described herein may be repeated or performed in parallel with one another or in parallel with different instances of the same or other similar acts.

FIG. 9 illustrates an example series of acts 900 for providing, for a vector graphics document, a mixed level-of-detail rendering comprising a raster image and a vector graphic subunit for display via a client device in accordance with one or more embodiments. The series of acts 900 can include an act 902 of, in response to a request to load a vector graphics document at a client device, downloading a raster image of the vector graphics document; an act 904 of downloading a vector graphic subunit of the vector graphics document; an act 906 of providing for display via a client device a mixed level-of-detail rendering; an act 908 of providing the raster image of the vector graphics document; and an act 910 of providing the vector graphic subunit as an overlay of the raster image.

In some embodiments, the series of acts 900 can include in response to a request to load a vector graphics document at a client device, downloading, by at least one processor, a raster image of the vector graphics document. The series of acts 900 can also include an act of downloading, by the at least one processor, a vector graphic subunit of the vector graphics document. The series of acts 900 can further include an act of providing, for display via the client device, a mixed level-of-detail rendering including the raster image of the vector graphics document and the vector graphic subunit as an overlay of the raster image such that the client device can modify the vector graphic subunit while downloading an additional vector graphic subunit.

In some implementations, downloading the vector graphic subunit includes determining graphic layers of the vector graphics document. Additionally, the series of acts 900 can include an act of selecting the vector graphic subunit based on the graphic layers of the vector graphics document.

In one or more embodiments, the series of acts 900 can include determining a rendering order of a plurality of vector graphics of the vector graphic subunit based on a layer list of the vector graphics document. The series of acts 900 can also include an act of providing, for display via the client device, the plurality of vector graphics of the vector graphic subunit according to the rendering order.

In one or more implementations, selecting the vector graphic subunit based on the graphic layers includes identifying a plurality of graphic design layout boundaries within the vector graphics document. The series of acts 900 can further include an act of selecting a priority graphic design layout boundary from the plurality of graphic design layout boundaries. Additionally, the series of acts 900 can include an act of determining the graphic layers of the vector graphics document that fall within the priority graphic design layout boundary.

In some embodiments, selecting the priority graphic design layout boundary includes determining historical user interaction with vector content within the priority graphic design layout boundary. The series of acts 900 can also include an act of selecting the priority graphic design layout boundary based on the historical user interaction with the vector content within the priority graphic design layout boundary.

In some implementations, selecting the priority graphic design layout boundary includes determining a measure of relevance between vector content within the priority graphic design layout boundary and a user of the client device. The series of acts 900 can further include an act of selecting the priority graphic design layout boundary based on the measure of relevance between the vector content within the priority graphic design layout boundary and the user of the client device.

In one or more embodiments, providing the vector graphic subunit as the overlay of the raster image includes generating a mask corresponding to the priority graphic design layout boundary. Additionally, the series of acts 900 can include an act of generating a masked raster image by applying the mask corresponding to the priority graphic design layout boundary to the raster image. The series of acts 900 can also include an act of providing, for display, the vector graphic subunit as the overlay to the masked raster image.

In one or more implementations, providing the vector graphic subunit as the overlay of the raster image includes generating a clipped vector graphic subunit by applying the priority graphic design layout boundary to the vector graphic subunit. The series of acts 900 can further include an act of providing the clipped vector graphic subunit over the masked raster image.

In some embodiments, the series of acts 900 can include downloading the additional vector graphic subunit of the vector graphics document. Additionally, the series of acts 900 can include an act of providing, for display via the client device, an additional masked level-of-detail rendering including the raster image of the vector graphics document with the vector graphic subunit and the additional vector graphic subunit as overlays of the raster image.

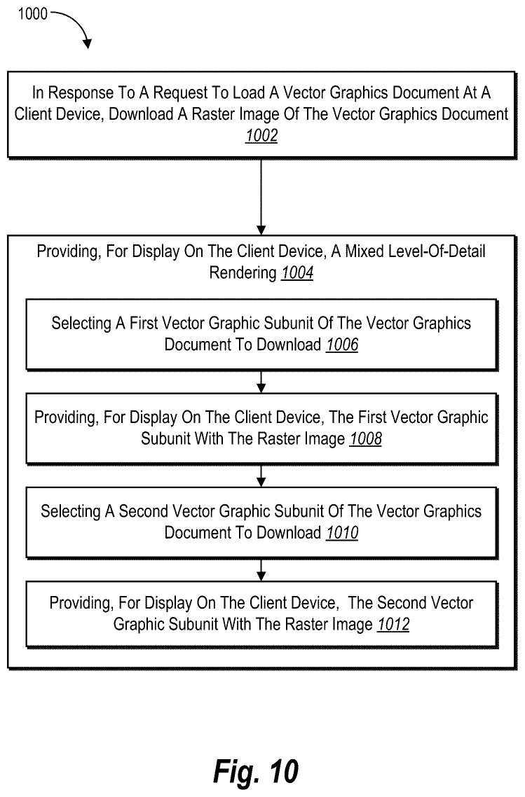

FIG. 10 illustrates an example series of acts 1000 for providing a mixed level-of-detail rendering of a vector graphics document for display on a client device by providing first and second vector graphic subunits of the vector graphics document with a raster image of the vector graphics document. The series of acts 1000 can include an act 1002 of, in response to a request to load a vector graphics document at a client device, download a raster image of the vector graphics document; an act 1004 of providing, for display on the client device, a mixed level-of-detail rendering; an act 1006 of selecting a first vector graphic subunit of the vector graphics document to download; an act 1008 of providing, for display on the client device, the first vector graphic subunit with the raster image; an act 1010 of selecting a second vector graphic subunit of the vector graphics document to download; and an act 1012 of providing, for display on the client device, the second vector graphic subunit with the raster image.

In some implementations, the series of acts 1000 can include, in response to a request to load a vector graphics document at a client device, downloading a raster image of the vector graphics document. The series of acts 1000 can also include an act of selecting a first vector graphic subunit of the vector graphics document to download. The series of acts 1000 can further include an act of providing, for display on the client device, the first vector graphic subunit with the raster image. Additionally, the series of acts 1000 can include an act of selecting a second vector graphic subunit of the vector graphics document to download. The series of acts 1000 can also include an act of providing, for display on the client device, a mixed level-of-detail rendering including the first vector graphic subunit and the second vector graphic subunit with the raster image.

In one or more embodiments, the series of acts 1000 can include selecting the first vector graphic subunit of the vector graphics document to download by selecting a priority graphic design layout boundary from a plurality of graphic design layout boundaries based on historical user interaction with the vector graphics document.

In one or more implementations, the series of acts 1000 can include selecting the first vector graphic subunit of the vector graphics document by determining graphic layers of the vector graphics document that fall within the priority graphic design layout boundary. The series of acts 1000 can further include an act of identifying vector graphics of the first vector graphic subunit corresponding to the graphic layers.

In some embodiments, the series of acts 1000 can include selecting the second vector graphic subunit of the vector graphics document based on historical user interactions with the vector graphics document by comparing user interactions across the plurality of graphic design layout boundaries within the vector graphics document.

In some implementations, providing the first vector graphic subunit with the raster image includes identifying a first priority graphic design layout boundary corresponding to the first vector graphic subunit. Additionally, the series of acts 1000 can include an act of generating a masked raster image by applying a mask corresponding to the first priority graphic design layout boundary to the raster image. The series of acts 1000 can also include an act of providing, for display within the first priority graphic design layout boundary, the first vector graphic subunit as an overlay to the masked raster image.

In one or more embodiments, providing the second vector graphic subunit with the raster image includes identifying a second priority graphic design layout boundary corresponding to the second vector graphic subunit. The series of acts 1000 can further include an act of applying an additional mask corresponding to the second priority graphic design layout boundary to the raster image. Additionally, the series of acts 1000 can include an act of providing, for display within the second priority graphic design layout boundary, the second vector graphic subunit as an additional overlay to the masked raster image.

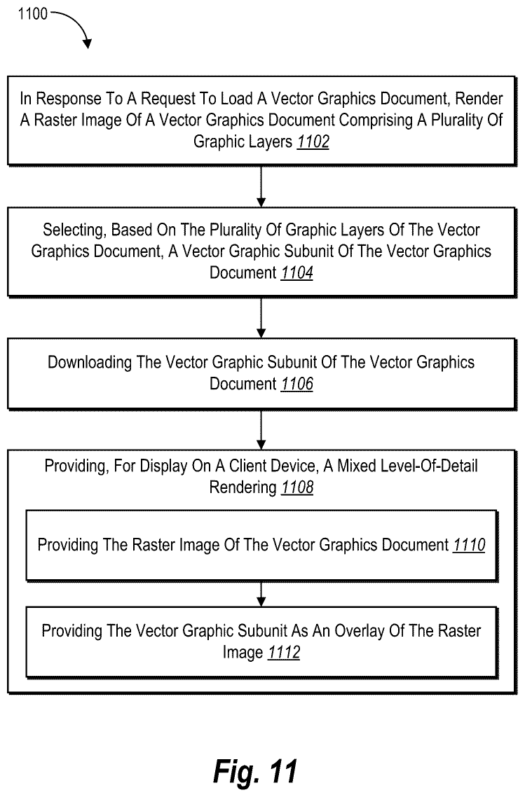

FIG. 11 illustrates an example series of acts 1100 for providing a mixed level-of-detail rendering of a vector graphics document by selecting a vector graphic subunit of the vector graphics document based on graphic layers of the vector graphics document. The series of acts 1100 can include an act 1102 of, in response to a request to load a vector graphics document, render a raster image of a vector graphics document comprising a plurality of graphic layers; an act 1104 of selecting, based on the plurality of graphic layers of the vector graphics document, a vector graphic subunit of the vector graphics document; an act 1106 of downloading the vector graphic subunit of the vector graphics document; an act 1108 of providing, for display on a client device, a mixed level-of-detail rendering; an act 1110 of providing the raster image of the vector graphics document; an act 1112 of providing the vector graphic subunit as an overlay of the raster image.

In one or more implementations, the series of acts 1100 can include in response to a request to load a vector graphics document, rendering a raster image of a vector graphics document including a plurality of graphic layers. The series of acts 1100 can also include an act of selecting, based on the plurality of graphic layers of the vector graphics document, a vector graphic subunit of the vector graphics document. The series of acts 1100 can further include an act of downloading the vector graphic subunit of the vector graphics document. Additionally, the series of acts 1100 can include an act of providing, for display on a client device, a mixed level-of-detail rendering including the vector graphic subunit as an overlay of the raster image.

In some embodiments, selecting the vector graphic subunit based on the plurality of graphic layers of the vector graphics document includes selecting a graphic design layout boundary from a plurality of graphic design layout boundaries of the vector graphics document. The series of acts 1100 can also include an act of determining graphic layers of the vector graphics document that fall within the graphic design layout boundary.

In some implementations, selecting the graphic design layout boundary from the plurality of graphic design layout boundaries of the vector graphics document includes determining a priority graphic design layout boundary based on a measure of relevance between vector content within the plurality of graphic design layout boundaries and a user of the client device.

In one or more embodiments, providing the vector graphic subunit as the overlay of the raster image for display on the client device includes generating a masked raster image by applying a mask corresponding to the graphic design layout boundary to the raster image.

In one or more implementations, providing the vector graphic subunit as the overlay of the raster image for display on the client device includes generating a masked vector graphic subunit by clipping vector graphics of the vector graphic subunit to the graphic design layout boundary. The series of acts 1100 can further include an act of providing, for display, the masked vector graphic subunit as the overlay to the masked raster image.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates a block diagram of exemplary computing device 1200 (e.g., the server(s) 102 and/or the client device(s) 110a-110n) that may be configured to perform one or more of the processes described above. One will appreciate that server(s) 102 and/or the client device(s) 110a-110n may comprise one or more computing devices such as computing device 1200. As shown by FIG. 12, computing device 1200 can comprise processor 1202, memory 1204, storage device 1206, I/O interface 1208, and communication interface 1210, which may be communicatively coupled by way of communication infrastructure 1212. While an exemplary computing device 1200 is shown in FIG. 12, the components illustrated in FIG. 12 are not intended to be limiting. Additional or alternative components may be used in other implementations. Furthermore, in certain implementations, computing device 1200 can include fewer components than those shown in FIG. 12. Components of computing device 1200 shown in FIG. 12 will now be described in additional detail.

In particular implementations, processor 1202 includes hardware for executing instructions, such as those making up a computer program. As an example and not by way of limitation, to execute instructions, processor 1202 may retrieve (or fetch) the instructions from an internal register, an internal cache, memory 1204, or storage device 1206 and decode and execute them. In particular implementations, processor 1202 may include one or more internal caches for data, instructions, or addresses. As an example and not by way of limitation, processor 1202 may include one or more instruction caches, one or more data caches, and one or more translation lookaside buffers (TLBs). Instructions in the instruction caches may be copies of instructions in memory 1204 or storage device 1206.

Memory 1204 may be used for storing data, metadata, and programs for execution by the processor(s). Memory 1204 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1204 may be internal or distributed memory.

Storage device 1206 includes storage for storing data or instructions. As an example and not by way of limitation, storage device 1206 can comprise a non-transitory storage medium described above. Storage device 1206 may include a hard disk drive (HDD), a floppy disk drive, flash memory, an optical disc, a magneto-optical disc, magnetic tape, or a Universal Serial Bus (USB) drive or a combination of two or more of these. Storage device 1206 may include removable or non-removable (or fixed) media, where appropriate. Storage device 1206 may be internal or external to computing device 1200. In particular implementations, storage device 1206 is non-volatile, solid-state memory. In other implementations, Storage device 1206 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1208 allows a user to provide input to, receive output from, and otherwise transfer data to and receive data from computing device 1200. I/O interface 1208 may include a mouse, a keypad or a keyboard, a touch screen, a camera, an optical scanner, network interface, modem, other known I/O devices or a combination of such I/O interfaces. I/O interface 1208 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1208 is configured to provide graphical data to a display for presentation to a user. The graphical data may be representative of one or more graphical user interfaces and/or any other graphical content as may serve a particular implementation.

Communication interface 1210 can include hardware, software, or both. In any event, communication interface 1210 can provide one or more interfaces for communication (such as, for example, packet-based communication) between computing device 1200 and one or more other computing devices or networks. As an example and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1210 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1210 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1210 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1212 may include hardware, software, or both that couples components of computing device 1200 to each other. As an example and not by way of limitation, communication infrastructure 1212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
in response to a request to load a vector graphics document at a client device, downloading, by at least one processor, a raster image of the vector graphics document;
downloading, by the at least one processor, a vector graphic subunit of the vector graphics document; and
providing, for display via the client device, a mixed level-of-detail rendering comprising the raster image of the vector graphics document and the vector graphic subunit as an overlay of the raster image such that the client device can modify the vector graphic subunit while downloading an additional vector graphic subunit.

2. The computer-implemented method of claim 1, wherein downloading the vector graphic subunit comprises:
determining graphic layers of the vector graphics document; and
selecting the vector graphic subunit based on the graphic layers of the vector graphics document.

3. The computer-implemented method of claim 2, further comprising:
determining a rendering order of a plurality of vector graphics of the vector graphic subunit based on a layer list of the vector graphics document; and
providing, for display via the client device, the plurality of vector graphics of the vector graphic subunit according to the rendering order.

4. The computer-implemented method of claim 2, wherein selecting the vector graphic subunit based on the graphic layers comprises:
identifying a plurality of graphic design layout boundaries within the vector graphics document;
selecting a priority graphic design layout boundary from the plurality of graphic design layout boundaries; and
determining the graphic layers of the vector graphics document that fall within the priority graphic design layout boundary.

5. The computer-implemented method of claim 4, wherein selecting the priority graphic design layout boundary comprises:
determining historical user interaction with vector content within the priority graphic design layout boundary; and
selecting the priority graphic design layout boundary based on the historical user interaction with the vector content within the priority graphic design layout boundary.

6. The computer-implemented method of claim 4, wherein selecting the priority graphic design layout boundary comprises:
determining a measure of relevance between vector content within the priority graphic design layout boundary and a user of the client device; and
selecting the priority graphic design layout boundary based on the measure of relevance between the vector content within the priority graphic design layout boundary and the user of the client device.

7. The computer-implemented method of claim 4, wherein providing the vector graphic subunit as the overlay of the raster image comprises:
generating a mask corresponding to the priority graphic design layout boundary;
generating a masked raster image by applying the mask corresponding to the priority graphic design layout boundary to the raster image; and
providing, for display, the vector graphic subunit as the overlay to the masked raster image.

8. The computer-implemented method of claim 7, wherein providing the vector graphic subunit as the overlay of the raster image comprises:
generating a clipped vector graphic subunit by applying the priority graphic design layout boundary to the vector graphic subunit; and
providing the clipped vector graphic subunit over the masked raster image.

9. The computer-implemented method of claim 1, further comprising:
downloading the additional vector graphic subunit of the vector graphics document; and
providing, for display via the client device, an additional masked level-of-detail rendering comprising the raster image of the vector graphics document with the vector graphic subunit and the additional vector graphic subunit as overlays of the raster image.

10. A system comprising:
one or more memory devices; and
one or more processors coupled to the one or more memory devices, the one or more processors configured to cause the system to:
in response to a request to load a vector graphics document at a client device, download a raster image of the vector graphics document;
select a first vector graphic subunit of the vector graphics document to download;
provide, for display on the client device, the first vector graphic subunit with the raster image;
select a second vector graphic subunit of the vector graphics document to download; and
provide, for display on the client device, a mixed level-of-detail rendering comprising the first vector graphic subunit and the second vector graphic subunit with the raster image.

11. The system of claim 10, wherein the one or more processors are further configured to select the first vector graphic subunit of the vector graphics document to download by: selecting a priority graphic design layout boundary from a plurality of graphic design layout boundaries based on historical user interaction with the vector graphics document.

12. The system of claim 11, wherein the one or more processors are further configured to select the first vector graphic subunit of the vector graphics document by:
determining graphic layers of the vector graphics document that fall within the priority graphic design layout boundary; and
identifying vector graphics of the first vector graphic subunit corresponding to the graphic layers.

13. The system of claim 11, wherein the one or more processors are further configured to select the second vector graphic subunit of the vector graphics document based on historical user interactions with the vector graphics document by comparing user interactions across the plurality of graphic design layout boundaries within the vector graphics document.

14. The system of claim 10, wherein providing the first vector graphic subunit with the raster image comprises:
identifying a first priority graphic design layout boundary corresponding to the first vector graphic subunit;
generating a masked raster image by applying a mask corresponding to the first priority graphic design layout boundary to the raster image; and
providing, for display within the first priority graphic design layout boundary, the first vector graphic subunit as an overlay to the masked raster image.

15. The system of claim 14, wherein providing the second vector graphic subunit with the raster image comprises:
identifying a second priority graphic design layout boundary corresponding to the second vector graphic subunit;
applying an additional mask corresponding to the second priority graphic design layout boundary to the raster image; and
providing, for display within the second priority graphic design layout boundary, the second vector graphic subunit as an additional overlay to the masked raster image.

16. A non-transitory computer readable medium storing executable instructions which, when executed by a processing device, cause the processing device to perform operations comprising:
in response to a request to load a vector graphics document, render a raster image of a vector graphics document comprising a plurality of graphic layers;
select, based on the plurality of graphic layers of the vector graphics document, a vector graphic subunit of the vector graphics document;
download the vector graphic subunit of the vector graphics document; and
provide, for display on a client device, a mixed level-of-detail rendering comprising the vector graphic subunit as an overlay of the raster image.

17. The non-transitory computer readable medium of claim 16, wherein selecting the vector graphic subunit based on the plurality of graphic layers of the vector graphics document comprises:
selecting a graphic design layout boundary from a plurality of graphic design layout boundaries of the vector graphics document; and
determining graphic layers of the vector graphics document that fall within the graphic design layout boundary.

18. The non-transitory computer readable medium of claim 17, wherein selecting the graphic design layout boundary from the plurality of graphic design layout boundaries of the vector graphics document comprises determining a priority graphic design layout boundary based on a measure of relevance between vector content within the plurality of graphic design layout boundaries and a user of the client device.

19. The non-transitory computer readable medium of claim 17, wherein providing the vector graphic subunit as the overlay of the raster image for display on the client device comprises generating a masked raster image by applying a mask corresponding to the graphic design layout boundary to the raster image.

20. The non-transitory computer readable medium of claim 19, wherein providing the vector graphic subunit as the overlay of the raster image for display on the client device comprises:
generating a masked vector graphic subunit by clipping vector graphics of the vector graphic subunit to the graphic design layout boundary; and
providing, for display, the masked vector graphic subunit as the overlay to the masked raster image.
